(19) United States
(12) Patent Application Publication
(10) Pub. No.: US 2026/0001172 A1
(43) Pub. Date: Jan. 1, 2026

(54) Obtaining method of tempering temperature range and application thereof, evaluation method of applicability of temper bead welding, and implementation method of temper bead welding

(71) Applicants: SUZHOU NUCLEAR POWER RESEARCH INSTITUTE CO., LTD., Suzhou (CN); China Nuclear Power Operations Co., Ltd., Shenzhen (CN)

(72) Inventors: Jianlin ZHANG, Suzhou (CN); Hai LI, Shenzhen (CN); Zhongbing CHEN, Suzhou (CN); Ping ZHU, Suzhou (CN); Xiaofeng WU, Shenzhen (CN); Li LU, Suzhou (CN); Yingjie CHEN, Shenzhen (CN); Jia YANG, Suzhou (CN); Shaohua YIN, Suzhou (CN); Wenqing LIU, Suzhou (CN)

(73) Assignees: SUZHOU NUCLEAR POWER RESEARCH INSTITUTE CO., LTD., Suzhou (CN); China Nuclear Power Operations Co., Ltd., Shenzhen (CN)

(21) Appl. No.: 19/319,747

(22) Filed: Sep. 5, 2025

Related U.S. Application Data
(63) Continuation of application No. PCT/CN2024/093820, filed on May 17, 2024.

(30) Foreign Application Priority Data
Jun. 25, 2023 (CN) 202310749622.3

(51) Int. Cl. B23K 31/12; B23K 9/095; B23K 31/02; B23K 103/04; G06F 30/23; G06F 119/08; G06F 119/18

(52) U.S. Cl. CPC B23K 31/12; B23K 9/0953; B23K 31/02; G06F 30/23; B23K 2103/04; G06F 2119/08; G06F 2119/18

(57) ABSTRACT

An obtaining method of the tempering temperature range includes following operations: determining a determination criterion of a tempering weld bead effect of a steel obtained after a welding of; determining an Ac1 temperature at which the steel begins to form or transform into austenite during a welding heating process; obtaining a temperature field distribution during a welding process, and determining a thermal cycle curve and a size distribution of the temperature field in different temperature ranges; using different peak tempering temperatures to simulate the thermal cycle curve and test performances on a microstructure of a weld coarse grained region, and determining a lowest peak temperature Tw and a highest peak temperature Tp meeting the determination criterion; and obtaining the tempering temperature range ΔTw according to the highest peak temperature Tp and the lowest peak temperature Tw of the steel, wherein Tp=Ac1 for some steel.

### CROSS REFERENCE TO RELATED APPLICATION

The present application is a continuation application of PCT application No. PCT/CN2024/093820 filed on May 17, 2024, which claims the benefit of CN202310749622.3 filed on Jun. 25, 2023. All the above are hereby incorporated by reference for all purposes.

### TECHNICAL FIELD

The disclosure relates to an obtaining method of a tempering temperature range and an application thereof, an evaluation method of an applicability of a temper bead welding, and an implementation method of the temper bead welding based on the tempering temperature range.

### BACKGROUND

Pressure-bearing special devices will inevitably be damaged or even defective in the service process Welding repair or replacement of spare parts is usually used to eliminate the damage or defects to ensure the integrity of the device structure. During the welding repair process, due to the effect of welding thermal cycle, the residual stress in the repaired part increases, the hardness increases, and the toughness of the heat-affected region deteriorates. Post-weld heat treatment is usually required to improve the performance. However, some objective conditions limit the application of post-weld heat treatment, so a welding repair technology without post-weld heat treatment is taught: Temper Bead Welding (TBW).

In Volume IX of the American ASME (2004 edition), QW490 defines the temper bead welding as: the welding bead is melted at a specific position or a weld surface in order to affect the metallurgical performances of the heat-affected region or previously melted weld metal. The temper bead welding can effectively improve the microstructure and performances of the heat-affected region of steel in multi-layer and multi-pass welding by reasonably controlling the welding bead geometry size, welding bead overlap and welding heat input.

With the mature development of temper bead welding, this technology is increasingly used in the welding repair of thick-walled components in the fields of thermal power, nuclear power, petrochemicals, etc., and temper bead welding technologies that do not require post-weld tempering heat treatment, such as half-welding bead tempering technology, controlled deposition technology, consistent weld layer technology, double-layer temper bead welding technology, and weld toe tempering technology, have been developed successively. The American ASME and French RCCM standard systems have also gradually included temper bead welding. In the American ASME standard Volume IX, Chapter II “Welding Procedure Assessment” QW-290 and Volume XI “Rules for In-Service Inspection of Nuclear Power Plant Components”, requirements for temper bead welding, such as welding procedure assessment, defect removal, welding method selection, welding rod selection, and tempering weld bead repair size, have been formulated. French RCC-M Volume IV S7600 “Welding Repair” also has relevant standards for temper bead welding. Unlike the US ASME specification, French RCC-M additionally requires an analysis of the impact of the weld repair area on the overall component stress.

In recent years, many domestic scholars have done a lot of work on the application research of temper bead welding for low alloy steel materials. For example, Shanghai Jiao Tong University uses double-layer tempering laser melting repair technology to make full use of the tempering effect of the subsequent melting layer on the previous melting layer, thereby eliminating the need for subsequent tempering heat treatment. Harbin Welding Research Institute systematically studied the welding bead size, heat-affected region structure, performance and welding thermal cycle changes of the welding bead of the SA508-3 steel. Suzhou Nuclear Power Research Institute CO., LTD. analyzed the structure and performances of 16MnD5 steel temper bead welding with 690 nickel-based welding wires. CGN Engineering Company completed the exploration of the simulated tempering welding bead repair process for 18MnD5 forgings using nickel-based alloy welding materials.

The American ASME standard stipulates that the temper bead welding is applicable to carbon steel and low alloy steel such as P-1, 3, 12A, 12B, and 12C, but it does not explain the reasons and whether other steels are also applicable to this technology. The American ASME standard QW-290 stipulates that the temper bead welding is limited to welding methods such as Shielded Metal Arc Welding (SMAW), Tungsten Inert Gas Welding (GTAW), Submerged Arc Welding (SAW), Gas Metal Arc Welding (GMAW) and Plasma Arc Welding (PAW). Wherein, gas metal arc welding includes Flux Cored Arc Welding (FCAW). It also does not explain the reasons and why other welding is not suitable for this technology. Moreover, most of these studies at home and abroad focus on the process exploration and engineering application of temper bead welding. At present, there is a lack of research on the applicability of temper bead welding in materials and welding methods, which limits the application of temper bead welding, especially in pressure-bearing special devices.

### SUMMARY

The disclosure provides an obtaining method of a tempering temperature range and an application thereof, and uses the obtaining method to an evaluation of an applicability of a temper bead welding and an implementation of the temper bead welding.

One or more embodiments of the disclosure provides the obtaining method of the tempering temperature range, which includes:
determining a determination criterion of a tempering weld bead of a steel;
determining an Ac1 temperature of the steel beginning to form or transform into austenite during a welding heating process;
obtaining a temperature field distribution during a welding process, and determining a thermal cycle curve and a size distribution of a temperature field in different temperature ranges;
using the thermal cycle curve in a coarse grained region to simulate the steel, obtaining a sample for welding the coarse grained region, and testing performances;
taking the sample for welding the coarse grained region, using different peak tempering temperatures to simulate the thermal cycle curve and test performances, and determining a lowest peak temperature Tw and a highest peak temperature Tp meeting the determination criterion; and
obtaining a tempering temperature range ΔTw according to the highest peak temperature Tp and the lowest peak temperature Tw.

In an embodiment of the disclosure, a lower limit of the tempering temperature range ΔTw is the lowest peak temperature Tw, and an upper limit is the highest peak temperature Tp.

In an embodiment of the disclosure, the lowest peak temperature Tw is a minimum tempering temperature of the steel with a tempering effect of a tempering weld bead.

In an embodiment of the disclosure, the highest peak temperature Tp is a maximum tempering temperature of the steel with the tempering effect of the tempering weld bead.

In an embodiment of the disclosure, when the steel is a nuclear grade 18MnD5 low alloy steel, a corresponding determination criterion of the tempering weld bead effect is: an impact energy is greater than or equal to 40 J at −20° C. and greater than or equal to 72 J at 20° C., a hardness value is a steel grade hardness+100HB, a yield strength is greater than or equal to 420 MPa at 20° C. and greater than or equal to 380 MPa at 350° C., and a tensile strength is from 580 Mpa to 720 MPa at 20° C. and greater than or equal to 540 MPa at 350° C.

In an embodiment of the disclosure, the temperature field distribution in the welding process is obtained by following operations: establishing a calculation model in the welding process through a finite element analysis calculation method, and obtaining the temperature field distribution in the welding process after verifing the calculation model through an experiment or a temperature collection method.

In an embodiment of the disclosure, when the steel is a nuclear grade 18MnD5 low alloy steel, the thermal cycle curve and the size distribution of the temperature field is set as follows: a melting region>1504° C., corresponding to a size W1; a temperature of the coarse grained region is from 1100° C. to 1504° C., corresponding to a size W2; a temperature of a fine grained region/complete recrystallization region is from Ac3 to 1100° C., corresponding to a size W3; a temperature of a critical region is from Ac1 to Ac3, corresponding to a size W4; and a temperature of a tempering temperature region is from Tw to Ac1, corresponding to a size W5, Tp of the 18MnD5 low alloy steel is Ac1.

In an embodiment of the disclosure, when the steel is the nuclear grade 18MnD5 low alloy steel, the Act of the steel is 721° C., a minimum tempering peak temperature Tw with the tempering weld bead effect is 500° C., the maximum tempering peak temperature Tp with the tempering weld bead effect is Ac1, and the corresponding tempering temperature range ΔTw is from 500° C. to 721° C.

One or more embodiments of the disclosure further provides an application of the tempering temperature range obtained by the obtaining method mentioned above in an evaluation method of determining an applicability of the temper bead welding.

Specifically, the evaluation method of the applicability of the temper bead welding, includes:
obtaining the tempering temperature range ΔTw of the steel according to the obtaining method according to the obtaining method mentioned above, wherein a size corresponding to the tempering temperature range ΔTw is the W5;
when W5 obtained under a certain welding process parameter is capable of covering the size W2 of the coarse grained region of the previous welding bead, then determining that the temper bead welding is suitable for this steel; and
when welding parameters is adjusted but W5 is not capable of covering the size W2 of the coarse grained region of the previous welding bead, then determining that the temper bead welding is not suitable for this steel.

According to the size of the tempering temperature range ΔTw of the obtained steel, it can be determined that the wider the tempering temperature range ΔTw is, the easier it is to achieve an effect of improving the microstructure and performance through adopting the temper bead welding, and vice versa.

For welding under a specific welding method, based on a size of the tempering temperature range ΔTw and a tempering temperature region size W5 in a temperature field during welding, it is determined whether the temper bead welding is suitable for a welding of this steel with this welding method, and then the welding parameters are adjusted to meet the implementation of the temper bead welding.

In an embodiment of the disclosure, the welding parameters include a heat input, a current, a voltage, a speed, an overlap amount, and a grinding amount.

Based on the obtaining method of tempering temperature range and the evaluation method of the applicability of the temper bead welding mentioned above, one or more embodiments of the disclosure further provides a welding method of tempering weld bead, which includes:
obtaining the tempering temperature range ΔTw of the steel according to the obtaining method according to the obtaining method mentioned above, wherein a size corresponding to the tempering temperature range ΔTw is W5;
when W5 obtained under a certain welding parameter is capable of covering a size W2 of the coarse grained region of a previous welding bead, then using the welding process parameter to weld a tempering weld bead; and
when W5 obtained under the certain welding process parameter cannot cover the size W2 of the coarse grained region of the previous welding bead, then adjusting the welding parameters to enable the W5 to cover the size W2 of the coarse grained region of the previous welding bead, and welding the tempering weld bead by using the adjusted welding parameters.

In summary, the disclosure provides the obtaining method of the tempering temperature range and the application thereof, the evaluation method of the applicability of the temper bead welding, and the implementation method of the temper bead welding based on the tempering temperature range. By obtaining the tempering temperature range, the obtained tempering temperature range can effectively characterize a welding effect of the temper bead welding and be used in an evaluation of the applicability of the temper bead welding. It may easily determine the steel and welding method applicable to the temper bead welding, avoid unnecessary losses due to improper selection, and provide a reasonable criterion for whether the temper bead welding can be effectively applied. The method has universal applicability.

### BRIEF DESCRIPTION OF THE DRAWINGS

In order to explain technical solutions of embodiments of the disclosure more clearly, the following will briefly introduce drawings used in a description of the embodiments or the conventional art. Obviously, the drawings in the following description are only some embodiments of the disclosure. For those of ordinary skill in the art, other drawings may be obtained based on these drawings without creative work.

FIG. 1 is a schematic view of a determination of a tempering temperature range under a corresponding temperature field in an iron-carbon phase diagram according to an embodiment of the disclosure.

FIG. 2 is a determination of a tempering temperature range given in combination with a determination criterion of a tempering weld bead effect according to an embodiment of the disclosure.

FIG. 3 is a schematic flowchart of obtaining and promoting the “tempering temperature range” according to an embodiment of the disclosure.

### DETAILED DESCRIPTION

In order to enable those skilled in the art to better understand technical features of the disclosure, the technical features in the embodiments of the disclosure will be clearly and completely described below in conjunction with the drawings in the embodiments of the disclosure. Obviously, the described embodiments are only embodiments of a part of the disclosure, rather than all of the embodiments. Based on the embodiments in this disclosure, all other embodiments obtained by ordinary technicians in this field without making any creative work should fall within a scope of protection of this disclosure.

There are many parameters that affect microstructures and performances of the temper bead welding after welding, such as a diameter of welding rod, a welding heat input, a welding bead overlap amount, a welding bead grinding amount, etc. Wherein, the heat input, welding bead overlap, etc. directly affect a geometric size distribution of the welding bead, which in turn affects a distribution of a hardened microstructure produced between adjacent welding beads, and directly determines a success of the temper bead welding.

However, there is no unified criterion to determine whether different metal materials and different welding methods are suitable for the temper bead welding. Based on this, the disclosure provides a “tempering temperature range” ΔTw that affects an effect of the tempering weld bead effect, and defines the criterion: ΔTw is a width of the tempering temperature range for a steel with a tendency to harden (a steel easy to harden) obtaining high-quality microstructure and performance under a welding thermal cycle implemented by the temper bead welding, and ΔTw=Tp−Tw, wherein Tw is a minimum tempering temperature of the steel with a tempering effect of the tempering weld bead, and Tp is a maximum tempering temperature of the steel with the tempering effect of the tempering weld bead, wherein the obtained Tp of a certain steel is an Ac1 temperature at which the formation or transformation into austenite starts during a welding heating process. At the same time, an obtaining method for the “tempering temperature range” is provided, then the “tempering temperature range” is derived and applied to other steels and welding methods to expand an application of tempering weld beads.

The disclosure provides an evaluation method of an applicability of the temper bead welding through the tempering temperature range ΔTw, the method includes S1-S6.

S1, determining a determination criterion.

When determining the determination criterion, according to a material of the steel, an industry standard or industry regulations corresponding to the steel is selected to determine the determination criterion of the tempering weld bead effect. In this embodiment, when the steel is a nuclear grade 18MnD5 low alloy steel, the determining criteria according to the standard requirements specified in the French RCC-M2000 standard is confirmed, and a corresponding determination criterion of the tempering weld bead effect is determined to be: an impact energy is greater than or equal to 40 J at −20° C. and greater than or equal to 72 J at 20° C., a hardness value is a steel grade hardness+100HB, a yield strength is greater than or equal to 420 MPa at 20° C. and greater than or equal to 380 MPa at 350° C., and a tensile strength is from 580 Mpa to 720 MPa at 20° C. and greater than or equal to 540 MPa at 350° C. In other embodiments, when selecting other steel, the determining criteria for the tempering weld bead effect may be determined according to the corresponding industry standards or industry regulations of the steel.

S2, determining an Ac1.

Determining the Ac1 means determining the temperature Ac1 of the steel beginning to form or transform into austenite during a welding heating process.

In this disclosure, the Ac1 of different steels may be obtained through experimental testing. In this disclosure, for example, referring to Chinese standard YB/T 5128-1993 “Measurement method of continuous cooling transformation curve of steel (dilation method)”, the Ac1 of the steel is determined by experimental methods.

In this embodiment, when the steel is nuclear grade 18MnD5 low alloy steel, the Ac1 temperature of the steel is obtained by the following operations: referring to Chinese standard YB/T 5128-1993 “Measurement method of continuous cooling transformation curve of steel (dilation method)” to determine the Ac1 temperature of the steel by experimental methods.

S3, obtaining a temperature field distribution.

Obtaining a temperature field distribution means obtaining the temperature field distribution during a welding process, and determining a thermal cycle curve and a size distribution of a temperature field in different temperature ranges.

The temperature field distribution in the welding process may be obtained by following operations: establishing a calculation model in the welding process through a finite element analysis calculation method, and obtaining the temperature field distribution in the welding process after verifing the calculation model through an experiment or a temperature collection method.

During the welding process, after the welding conditions are set, the temperature field distribution under this welding conditions is obtained. In this disclosure, the welding process is divided into, for example, a melting region>T1 (size W1), a coarse grained region T2˜T1 (size W2), a fine grained region/complete recrystallization region T3˜T2 (size W3), a critical region T4˜T3 (size W4), and a tempering temperature region T5˜T4 (size W5). Wherein, T1 is a solidus temperature of the steel, T2 is a rapid grain growth temperature, for example, around 1100° C., T3 is a temperature at which the steel stops forming or transforming into austenite during a heating process, which means Ac3, T4 is a highest peak temperature that meets the determination criterion during welding, and T5 is a lowest peak temperature that meets the determination criterion during welding.

In this embodiment, when the steel is the nuclear grade 18MnD5 low alloy steel, the obtained thermal cycle curve and the size distribution of the temperature field is set as follows: the melting region>1504° C., (size W1), the temperature of the coarse grained region is from 1100° C. to 1504° C., (size W2); a temperature of a fine grained region/complete recrystallization region is from Ac3 to 1100° C., (size W3); a temperature of a critical region is from Ac1 to Ac3, (size W4); and a temperature of the tempering temperature region is from Tw to Ac1, (size W5). Wherein, when the steel is the nuclear grade 18MnD5 low alloy steel, the Ac1 is the same as the highest peak temperature that meets the determination criterion during welding. The Ac1 is a temperature at which the steel begins to form or transform into austenite during the heating process.

S4, obtaining the lowest peak temperature Tw and the highest peak temperature Tp,
which means using the thermal cycle curve in the coarse grained region to simulate the steel, obtaining a sample for welding the coarse grained region, and testing performances; This operation is to obtain the sample for the coarse grained region, which means a sample within the W2. Since a performance of the coarse grained region is worst during the welding process, the coarse grained region is selected as the sample to confirm whether the coarse grained region meets the determination criterion after simulating the thermal cycle curve at the tempering temperature to ensure that a performance of the welding area meets use requirements.

For the sample for welding the coarse grained region, different peak tempering temperatures are used to simulate the thermal cycle curve and test performances, and a lowest peak temperature Tw and a highest peak temperature Tp meeting the determination criterion are determined. This operation is to subject the sample in the coarse grained region to a second thermal cycle or tempering to obtain the Tw and the Tp.

The lowest peak temperature Tw is a minimum tempering temperature of the steel with the tempering effect of the tempering weld bead.

The highest peak temperature Tp is a maximum tempering temperature of the steel with the tempering effect of the tempering weld bead.

In the disclosure, Tp of a certain steel is the Ac1 temperature at which the steel begins to form or transform into austenite during the welding heating process, such as the nuclear grade 18MnD5 low alloy steel provided in this embodiment. In other embodiments, when other steel is selected, the obtained Tp is, for example, different from Ac1, or higher than Ac1.

S5, obtaining the tempering temperature range ΔTw,
which means obtaining the tempering temperature range ΔTw according to the highest peak temperature Tp and the lowest peak temperature Tw. ΔTw is defined as a width of the tempering temperature range for the steel with hardening tendency (the steel easy to harden) obtaining the high-quality microstructure and performances under the welding thermal cycle implemented by temper bead welding.

The tempering temperature range ΔTw=Tp−Tw, which means that a lower limit of the tempering temperature range ΔTw is the lowest peak temperature Tw, and an upper limit is the highest peak temperature Tp.

S6, tempering temperature range ΔTw in an evaluation of the applicability of temper bead welding and the application of tempering weld technology in welding is provided.

Based on a size of the tempering temperature range ΔTw and a tempering temperature region size W5 in a temperature field during welding, it is determined whether the temper bead welding is suitable for a welding of this steel with this welding method, and then the welding parameters are adjusted to meet the implementation of the temper bead welding. The welding parameters mainly include welding process parameters (including heat input, current, voltage, rate), overlap, grinding, etc.

The above S1 to S5 are the obtaining methods of the tempering temperature range ΔTw. The obtained tempering temperature range ΔTw is combined with the above S6, which means that the tempering temperature range ΔTw is applied to the evaluation of the applicability of the temper bead welding, and an evaluation method for the applicability of the temper bead welding is obtained.

Specifically, the evaluation method of the applicability of the temper bead welding, includes:
obtaining the tempering temperature range ΔTw of the steel according to the obtaining method according to the obtaining method mentioned above, wherein the size corresponding to the tempering temperature range ΔTw is the W5;
when W5 obtained under a certain welding process parameter is capable of covering the size W2 of the coarse grained region of the previous welding bead, then determining that the temper bead welding is suitable for this steel; and
when W5 obtained under a certain welding process parameter is not capable of covering the size W2 of the coarse grained region of the previous welding bead, then adjusting the welding parameters, but W5 still cannot cover the size W2 of the coarse grained region of the previous welding bead after all adjustments, then determining that the temper bead welding is not suitable for this steel.

An implementation method of a temper bead welding includes:
obtaining the tempering temperature range ΔTw of the steel-according to the obtaining method mentioned above, wherein the size corresponding to the tempering temperature range ΔTw is the W5;
when W5 obtained under a certain welding parameter is capable of covering the size W2 of the coarse grained region of the previous welding bead, then using the welding process parameter to weld a tempering bead; and
when W5 obtained under a certain welding process parameter is not capable of covering the size W2 of the coarse grained region of the previous welding bead, then adjusting the welding parameters to enable the W5 to cover the size W2 of the coarse grained region of the previous welding bead, and welding the tempering weld bead by using the adjusted welding parameters.

### Embodiment

The applicabilities of tempering temperature ranges for different steels under different welding methods are different. This embodiment takes a welding of nuclear-grade 18MnD5 low alloy steel using temper bead welding and SMAW welding method as an example to explain a process of obtaining the tempering temperature range and use it in the evaluation of the applicability of temper bead welding:
operation 1: referring to standard requirements of French RCC-M2000 standard for nuclear-grade 18MnD5 low alloy steel, a determination criterion of a microstructure and performance of nuclear-grade 18MnD5 low alloy steel after tempering welding are as follows: an impact energy is greater than or equal to 40 J at −20° C. and greater than or equal to 72 J at 20° C., a hardness value is a steel grade hardness+100HB, a yield strength is greater than or equal to 420 MPa at 20° C. and greater than or equal to 380 MPa at 350° C., and a tensile strength is from 580 Mpa to 720 MPa at 20° C. and greater than or equal to 540 MPa at 350° C.
Operation 2: referring to Chinese standard YB/T 5128-1993, the Ac1 temperature of the nuclear-grade 18MnD5 low alloy steel is determined experimentally, which means that the Ac1=721° C.
Operation 3: through a finite element analysis method, a calculation model of the nuclear-grade 18MnD5 low alloy steel in a SMAW welding process is established. After verifying the model through an experimental/temperature obtaining method, a temperature field distribution of the welding process is obtained, and the thermal cycle curves and size distribution in different temperature ranges are determined.

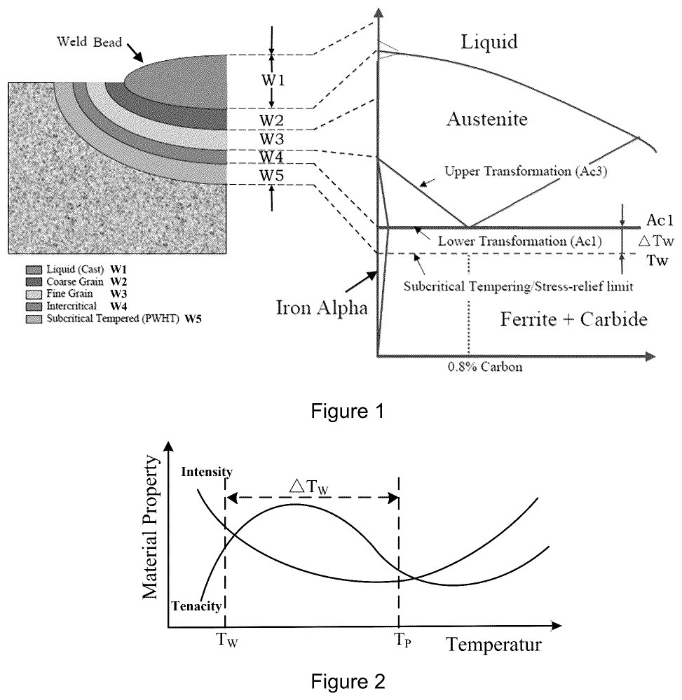

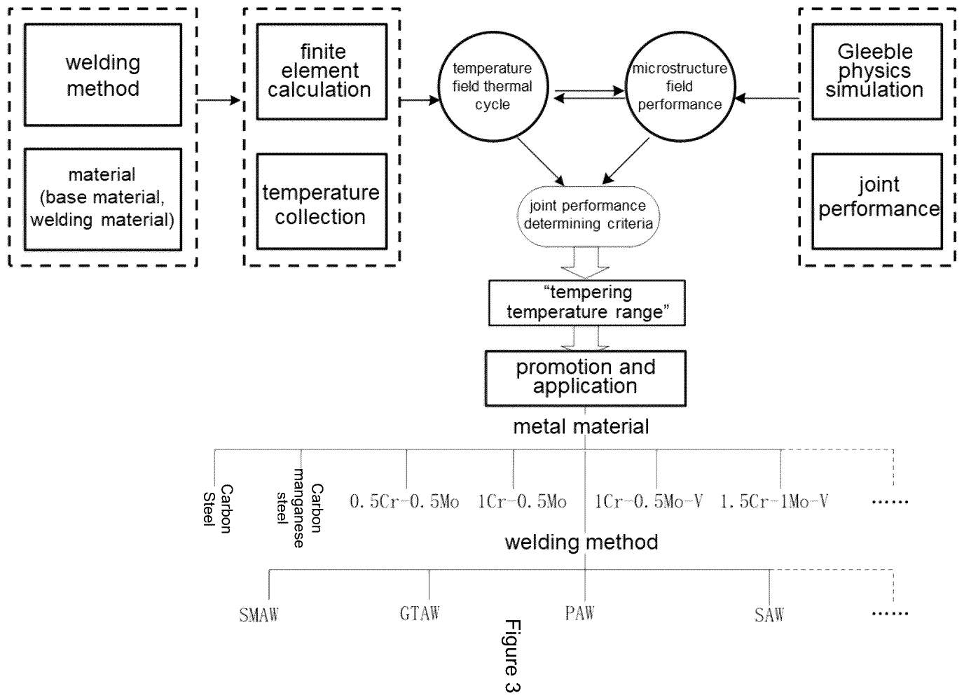

Please refer to FIG. 1 and FIG. 2. The thermal cycle curve and the size distribution of the temperature field is set as follows: the melting region>1504° C., (corresponding to the size W1), the temperature of the coarse grained region is from 1100° C. to 1504° C., (corresponding to the size W2); the temperature of the fine grained region/complete recrystallization region is from Ac3 to 1100° C., (corresponding to the size W3); the temperature of the critical region is from Ac1 to Ac3, (corresponding to the size W4); and the temperature of the tempering temperature region is from Tw to Ac1, (corresponding to the size W5).
Operation 4: through Gleeble thermal simulation test or other testing methods, using different peak tempering temperatures to simulate the thermal cycle curve in the coarse grained region and testing performances, and determining the “lowest peak temperature” Tw and the “highest peak temperature” Tp meeting the determination criterion in the operation 1.

Wherein, Tw is the minimum tempering temperature of the steel with the tempering effect of the tempering weld bead, and Tp is the maximum tempering temperature of the steel with the tempering effect of the tempering weld bead. In this embodiment, the measured Tw=500° C. and the measured Tp=Ac1 of the 18MnD5 low alloy steel.
Operation 5: using the Tw and the Tp respectively obtained in operation 4, calculating the “tempering temperature range” ΔTw according to the formula ΔTw=Tp−Tw, as shown in FIG. 1 and FIG. 2.

Wherein, ΔTw is defined as a width of the tempering temperature range for the steel with hardening tendency (the steel easy to harden) obtaining the high-quality microstructure and performances under the welding thermal cycle implemented by temper bead welding. In this embodiment, the calculated ΔTw of the nuclear grade 18MnD5 low alloy steel is 221° C.
Operation 6: according to the ΔTw obtained in operation 5, combined with the size distribution of the temperature field obtained in operation 3, determining the size W5 of the tempering temperature region, and determining a welding bead arrangement that can achieve the tempering effect of the previous welding bead. A tempering weld bead microstructure with excellent performance may be obtained by changing the overlap, the grinding, the welding heat input and other parameters.

The “tempering temperature range ΔTw” obtained according to the above operations may be extended and applied to any steel and different welding methods. If the ΔTw of a specific metal material under a certain welding method is large enough, a high-quality welded joint can be obtained through the temper bead welding, otherwise it is not easy to achieve. If a size range of the tempering temperature region W5 of a subsequent welding bead just covers the coarse grained region W2 of a previous welding bead, then the tempering weld bead technology under this welding process is applicable, otherwise it is not applicable. If it is not applicable, a size distribution of a temperature field of the tempering weld bead may be comprehensively controlled by changing the overlap, the grinding, the welding heat input and other parameters, so that the size W5 of the subsequent welding bead obtained after adjusting the parameters covers the size W2 of the previous welding bead, and a tempering weld bead microstructure with excellent performance may also be obtained, thereby meeting use conditions of the temper bead welding. If after changing the welding parameters, the size W5 of the subsequent welding bead obtained after adjusting the parameters still cannot cover the size W2 of the previous welding bead, then the temper bead welding is not suitable for welding this steel under this welding method.

Please refer to FIG. 3. Different materials have different microstructures and performances after the welding thermal cycles. This disclosure selects representative steels, such as 20G, 18MnD5, BHW35, 410S, P22, P91, WC6, WC9, etc., to obtain the “tempering temperature range”, explores an influence of temper bead welding on a heat-affected region of steel, and gets the following conclusions: the tempering temperature range ΔTw of carbon steel and low alloy steel is above 150° C. or even 200° C., while the tempering temperature range ΔTw of medium alloy steel and high alloy steel is less than 100° C. or even 0° C. The size W5 of the tempering temperature region of the carbon steel and the low alloy steel is also larger than that of medium alloy steel and high alloy steel. Therefore, it is easier for the carbon steel and the low alloy steel to achieve an optimizing microstructures and performances through temper bead welding, while it is not easy for the medium alloy steel and the high alloy steel to achieve this optimization.

Based on the above method, 18MnD5, BHW35, and WC6 steels represented by deaerators, steam drums, and valves are selected. According to requirements of the American ASME and French RCCM standards, a finite element simulation calculation is first used to verify the welding thermal cycle of a welding temperature field, and the GLEEBLE thermal simulation is combined to simulate and verify a performance change law of the microstructure of the coarse grained region. Then, a hardness is compared and analyzed with normal welding specimens with/without heat treatment, and a change law of the tempering weld bead on improving the microstructures and performances is analyzed. Finally, a confirmatory test of a tempering process evaluation is performed to obtain the final qualified welding joint, and results are applied to repair of deaerators, steam drums, valve bodies, cylinders, and pipelines without heat treatment of tempering welds.

On a key special device that is difficult to heat treat, the evaluation method and welding method in this application may be used to easily determine the steel and the welding method suitable for the temper bead welding, which avoids unnecessary losses due to improper selection. The evaluation method of the disclosure may provide a reasonable criterion for whether the temper bead welding can be effectively applied, has universal applicability, and may be extended to welding manufacturing and welding repair fields of different industries. This achievement has been successfully applied to a special pressure-bearing device in nuclear power and thermal power plants, such as repair of deaerators, steam drums, valves, cylinders, and pipelines, which ensures a safe and reliable operation of machines. This research results may ensure a safety of special device components after repair, and realize green repair technology that saves materials, energy, shortens construction period, and is environmentally friendly. It provides customers with solutions for restoring functional performance of device components after failure. It has a value of promoting and applying welding repair of similar device in domestic power plants or other industries, improving safety and reliability, and enhancing economic and social benefits.

The above embodiments are only for illustrating technical concept and features of the disclosure, and the disclosure is to enable people familiar with this technology to understand a content of the disclosure and implement it accordingly, and they cannot be used to limit a scope of protection of the disclosure. All equivalent changes or modifications made according to a spirit and essence of this disclosure should be included in the protection scope of this disclosure.

What is claimed is:

1. An obtaining method of a tempering temperature range, comprising:
determining a determination criterion of a tempering weld bead effect of a steel;
determining an Ac1 temperature of the steel beginning to form or transform into austenite during a welding heating process;
obtaining a temperature field distribution during a welding process, and determining a thermal cycle curve and a size distribution of a temperature field in different temperature ranges;
using the thermal cycle curve in a coarse grained region to simulate the steel, obtaining a sample for welding the coarse grained region, and testing performances of the sample;
taking the sample for welding the coarse grained region, using different peak tempering temperatures to simulate the thermal cycle curve and test performances, and determining a lowest peak temperature Tw and a highest peak temperature Tp meeting the determination criterion; and
obtaining a tempering temperature range ΔTw according to the highest peak temperature Tp and the lowest peak temperature Tw.

2. The obtaining method according to claim 1, wherein, a lower limit of the tempering temperature range ΔTw is the lowest peak temperature Tw, and an upper limit is the highest peak temperature Tp.

3. The obtaining method according to claim 1, wherein, the lowest peak temperature Tw is a minimum tempering temperature of the steel with a tempering effect of a tempering weld bead.

4. The obtaining method according to claim 1, wherein, the highest peak temperature Tp is a maximum tempering temperature of the steel with the tempering effect of the tempering weld bead.

5. The obtaining method according to claim 1, wherein, when the steel is a nuclear grade 18MnD5 low alloy steel, a corresponding determination criterion of the tempering weld bead effect is: an impact energy is greater than or equal to 40 J at −20° C. and greater than or equal to 72 J at 20° C., a hardness value is a steel grade hardness+100HB, a yield strength is greater than or equal to 420 MPa at 20° C. and greater than or equal to 380 MPa at 350° C., and a tensile strength is from 580 Mpa to 720 MPa at 20° C. and greater than or equal to 540 MPa at 350° C.

6. The obtaining method according to claim 1, wherein, the temperature field distribution in the welding process is obtained by following operations: establishing a calculation model in the welding process through a finite element analysis calculation method, and obtaining the temperature field distribution in the welding process after verifying the calculation model through an experiment or a temperature collection method.

7. The obtaining method according to claim 6, wherein, when the steel is a nuclear grade 18MnD5 low alloy steel, the thermal cycle curve and the size distribution of the temperature field is set as follows: a melting region>1504° C., corresponding to a size W1; a temperature of the coarse grained region is from 1100° C. to 1504° C., corresponding to a size W2; a temperature of a fine grained region/complete recrystallization region is from Ac3 to 1100° C., corresponding to a size W3; a temperature of a critical region is from Ac1 to Ac3, corresponding to a size W4; and a temperature of a tempering temperature region is from Tw to Ac1, corresponding to a size W5, Tp of the 18MnD5 low alloy steel is Ac1.

8. The obtaining method according to claim 7, wherein, when the steel is the nuclear grade 18MnD5 low alloy steel, the Ac1 of the steel is 721° C., a minimum tempering peak temperature Tw with the tempering weld bead effect is 500° C., the maximum tempering peak temperature Tp with the tempering weld bead effect is Ac1, and the corresponding tempering temperature range ΔTw is from 500° C. to 721° C.

9. An application of the tempering temperature range obtained by the obtaining method according to claim 1 in an evaluation method of determining an applicability of temper bead welding.

10. An evaluation method of an applicability of temper bead welding, comprising:
obtaining the tempering temperature range ΔTw of the steel according to the obtaining method according claim 1, wherein a size corresponding to the tempering temperature range ΔTw is the W5;
when W5 obtained under a certain welding process parameter is capable of covering a size W2 of the coarse grained region of a previous welding bead, then determining that the temper bead welding is suitable for the steel; and
when any adjustment of welding parameters is not possible to make W5 cover the size W2 of the coarse grained region of the previous welding bead, then determining that the temper bead welding is not suitable for the steel.

11. The evaluation method according to claim 10, wherein, the welding parameters comprise a heat input, a current, a voltage, a speed, an overlap amount, and a grinding amount.

12. An implementation method of temper bead welding, comprising:
obtaining the tempering temperature range ΔTw of the steel according to the obtaining method according to claim 1, wherein a size corresponding to the tempering temperature range ΔTw is W5;
when W5 obtained under a certain welding parameter is capable of covering a size W2 of the coarse grained region of a previous welding bead, then using the welding process parameter to weld a tempering weld bead; and
when W5 obtained under the certain welding process parameter cannot cover the size W2 of the coarse grained region of the previous welding bead, then adjusting the welding parameters to enable the W5 to cover the size W2 of the coarse grained region of the previous welding bead, and welding the tempering weld bead by using the adjusted welding parameters.
